(19) United States
(12) Patent Application Publication
(10) Pub. No.: US 2015/0135599 A1
(43) Pub. Date: May 21, 2015

(54) DOUBLE LEAF HATCH COVER WITH CENTRAL SEAL

(71) Applicant: Versa-Steel, Inc., Portland, OR (US)

(72) Inventor: Bernard A. Mares, Portland, OR (US)

(73) Assignee: Versa-Steel, Inc.

(21) Appl. No.: 14/523,512

(22) Filed: Oct. 24, 2014

Related U.S. Application Data
(60) Provisional application No. 61/905,737, filed on Nov. 18, 2013.

(51) Int. Cl. E06B 7/22; E06B 1/34; E06B 7/26; E06B 7/28

(52) U.S. Cl. CPC E06B 7/22; E06B 7/28; E06B 1/34; E06B 7/26
USPC 49/465; 49/483.1

(57) ABSTRACT

A double leaf hatch cover comprises first and second hatch cover portions. Cooperating interfitting seal components seal the gap between adjacent edges of the hatch cover portions. A dam structure is provided along the edge of a first of the hatch cover portions. The dam portion includes an upwardly extending dam projection. An elongated shield is provided along the edge of the second of the hatch cover portions. The shield overlies the dam with the dam projection engaging a gap seal member in the channel when the hatch cover portions are closed. A peripheral seal is provided along the upper edge of an upright wall of the frame. A side gap seal is provided at each of the respective sides of the hatch cover to seal the side gap between the perimeter seal and the gap seal member.

### CROSS REFERENCE TO RELATED APPLICATION

This application claims the benefit of U.S. Provisional Application Ser. No. 61/905,737, entitled DOUBLE LEAF HATCH COVER WITH CENTRAL SEAL, filed on Nov. 18, 2013.

### BACKGROUND

In a number of hatch cover applications, it is highly desirable to prevent the entry of rainwater or other liquids, as well as pests through the hatch cover into a chamber, vault, tank or other area closed by the hatch cover.

Gutter style hatch covers of the double door or leaf variety have been used for covering water reservoirs access openings, and the like. In general, these types of hatch covers use a gutter that surrounded the hatch opening. The doors have side and end flanges that fit within the gutter when the doors are closed. Rainwater impinging on the doors flows past the doors and downwardly to the gutters and then to a gutter drain. In one approach, an elongated strip of rubber mounted to the edge of one door is contacted by the edge of the other door to close the gap when the doors are closed. These gutter style hatch covers can leak and the gutters can consist of a place for harboring vectors, such as mice.

A need exists for improved hatch covers, especially for openings where double leaves or doors are used to cover a hatch opening.

### SUMMARY

In accordance with an embodiment, a double leaf hatch cover is disclosed with first and second hatch cover portions that cover a hatch cover opening when closed. An elongated gap between adjacent edges of the closed hatch cover portions typically extends from side to side of the hatch cover. In accordance with this disclosure, cooperating interfitting seal components are utilized. Specifically, a dam structure is provided along a first of the hatch cover portion edges. The dam portion includes an upwardly extending dam projection. An elongated shield is provided along the edge of upwardly extending dam projection. An elongated shield is provided along the edge of the second of the hatch cover portions. The shield overlies the dam with the dam projection extending into a receiving channel of the shield when the hatch cover portions are closed. A gap seal member in the channel is engaged by the dam projection to assist in sealing the gap. The hatch cover portions can be hinged to or placed on a frame. A peripheral seal is provided along the upper edge of an upright wall of the frame to engage an undersurface of the respective hatch cover portions to seal the perimeter of the hatch cover. In addition, a side gap seal is provided at each of the respective sides of the assembly to seal the gap that otherwise would exist between the perimeter seal and the gap seal member.

In accordance with an embodiment, a hatch cover comprises a frame with an opening through the frame, first and second hatch cover portions overlying the opening and closing the opening when the first and second hatch cover portions are in a closed position; the first hatch cover portion having a first edge positioned to extend across the opening when the first cover portion is in a closed position, the second hatch cover portion having a second edge positioned to extend across the opening when the second hatch cover portion is in a closed position; an elongated dam projecting outwardly from the first hatch cover portion and extending along the first edge; a shield projecting outwardly from the first hatch cover portion and extending along the second edge, the shield defining an elongated channel positioned to receive the dam therein when the first and second hatch cover portions are in a closed position; and a gap seal member positioned in the channel and engaged by the dam projection when the first and second hatch cover portions are in the closed position.

As an aspect of an embodiment, the frame can comprise a frame base and a wall projecting outwardly from the frame base, the wall surrounding the opening, the wall having a distal end portion spaced from the frame base, a perimeter seal coupled to the distal end portion of the frame wall and positioned to provide a seal between the distal end portion of the frame wall and the first and second hatch cover portions when the first and second hatch cover portions are in a closed position. The perimeter seal can extend along the entire perimeter of the frame wall.

As another aspect of an embodiment, the hatch cover can have first and second hatch cover sides, wherein the first and second edges each extend from the first hatch cover side to the second hatch cover side, the hatch cover comprising first and second side gap seals each coupled to a respective one of the dams and the shield, the side gap seals being configured to engage the gap seal member and the perimeter seal, the first side gap seal being positioned to seal the space between the perimeter seal and the gap seal member at a location adjacent to the first hatch cover side, and the second side gap seal being positioned to seal the space between the perimeter seal and the gap seal member at a location adjacent to the second hatch cover side.

As a further aspect of an embodiment, the dam can have a first side gap seal receiving opening adjacent to the first hatch cover side and a second side gap seal receiving opening adjacent to the second hatch cover side, the first side gap seal can comprise a first seal body positioned at least in part within and associated with the first side gap seal receiving opening, the second side gap seal comprising a second end gap seal body positioned at least in part within and associated with the second end gap seal receiving opening, the first side gap seal comprising respective first and second leg portions positioned at opposite sides of the dam and extending from the first seal body and into engagement with the gap seal member when the first and second hatch cover portions are in a closed position, the first side gap seal comprising a respective third leg extending from the first seal body in a direction away from the first and second legs of the first side gap seal and into engagement with the perimeter seal when the first and second hatch cover portion are in a closed position; and the second side gap seal comprising respective first and second leg portions positioned at opposite sides of the dam and extending from the second seal body into engagement with the gap seal member when the first and second hatch cover portions are in a closed position, the second side gap seal comprising a respective third leg extending from the second seal body and in a direction away from the first and second legs of the second side gap seal and into engagement with the perimeter seal when the first and second hatch cover portions are in a closed position.

As yet another aspect of an embodiment, the third leg of each of the first and second side gap seals can comprise an enlarged foot portion positioned to abut the perimeter seal when the first and second hatch cover portions are in a closed position. In addition, the shield can comprise at least one side gap seal engaging projection positioned to engage and compress the respective side gap seal feet of the first and second side gap seals when the first and second hatch cover portions are in a closed position.

As further aspects of an embodiment, the side gap seal receiving openings can be bounded on all sides by a portion of the dam. The side gap seal receiving opening can be rectangular.

As yet another aspect of an embodiment, the shield and dam are each substantially u-shaped with the u-shaped elements being inverted in the case of an upwardly opening hatch cover.

As still another3 aspect of an embodiment, the first and second hatch cover portions can be substantially rectangular with each of the first and second hatch cover portions comprising a hatch cover body portion. Each of the hatch cover portions is positioned to overlie a portion of the opening when in a closed position. The first and second hatch cover portions can each comprise a hatch cover end portion projecting downwardly from the hatch cover body portion at a location spaced from the gap. The first and second hatch cover side portions can be connected to the hatch cover end portion and can project downwardly from the associated hatch cover body portion at opposed sides of the hatch cover body portion. In addition, the frame can also be rectangular.

As yet another aspect of an embodiment, the dam can be mounted to a first cover portion and extend along the length of a gap between the adjacent edges of the first and second hatch cover portions. The dam can comprise a dam base coupled to the first cover portion and a dam projection extending outwardly from the dam base. The shield can be mounted to the second cover portion and extend along the length of the gap. The shield can comprise a shield base coupled to the second cover portion and extending along the length of the gap, a gap cover portion positioned to overlie the gap. The gap cover portion can comprise a first shield leg portion extending from the shield base portion and away from the second cover portion, a cross member portion overlying the gap and spaced from the first and second cover portions, and a second shield leg portion extending from the cross member position toward the first cover portion. The dam and shield in this embodiment can be positioned and configured such that the dam projection is positioned between the first and second leg portions when the first and second hatch cover portions are in a closed position. A gap seal member can be positioned between the first and second leg portions, the gap seal member being engaged by the dam projection when the first and second hatch cover portions are in a closed position. This embodiment also desirably comprises a perimeter seal positioned to seal the gap between the distal end of a frame wall surrounding the opening covered by the hatch cover and the first and second hatch cover portions when the first and second hatch cover portions are in a closed position. In addition, the embodiment also desirably comprises first and second side gap seals each coupled to a respective one of the dams and the shield and configured to engage the gap seal member and the perimeter seal, the first side gap seal being positioned to seal the space between the perimeter seal and the gap seal member at a first end portion of the gap, and the second side gap seal being positioned to seal the space between the perimeter seal and the gap seal member at a second end portion of the gap.

These and other features and advantages of the hatch cover of the present invention will become more apparent with reference to the following description and drawings.

### DESCRIPTION OF THE DRAWINGS

FIG. 1 is an exploded perspective view of an embodiment of a double leaf hatch cover in accordance with this disclosure.

FIG. 2 illustrates the hatch cover of FIG. 1 with one side or leaf of the hatch cover shown lifted partially from a supporting frame of the hatch cover.

FIG. 3 is another perspective view of a leaf of the hatch cover lifted from the supporting frame.

FIG. 4 is a close up view of a portion of the hatch cover leaf lifted from the frame.

FIG. 5 is a close up view of the hatch cover with the hatch cover leaves in a closed position.

FIG. 6 is a partial vertical sectional view of the hatch cover of FIG. 2.

FIG. 7 is a sectional view through a central joint designed to seal the gap between two leaves of the hatch cover.

FIG. 8 is a vertical sectional view through a portion of the hatch cover with closed leaves.

FIGS. 9-13 illustrate various views of an exemplary seal that can be used to seal the gap at the sides of the hatch cover.

### DESCRIPTION

Throughout this disclosure, when a reference is made to a first element being coupled to a second element, the term “coupled” is to be construed to mean both direct connection of the elements as well as indirect connection of the elements by way of one or more additional intervening elements. Also, the singular terms “a”, “and”, and “first”, mean both the singular and the plural unless the term is qualified to expressly indicate that it only refers to a singular element, such as by using the phase “only one”. Thus, for example, if two of a particular element are present, there is also “a” or “an” of such element that is present. In addition, the term “and/or” when used in this document is to be construed to include the conjunctive “and”, the disjunctive “or”, and both “and” and “or”. Also, the term “includes” has the same meaning as “comprises.” In addition, the terms “side” and “end” have the same meaning in that an “end” can be a “side” and vice versa. The terms “downward” and “upright” are relative terms. The terms are met if a structure can be oriented in an orientation with a component described as upright extending generally upwardly and a component described as downward extending downwardly.

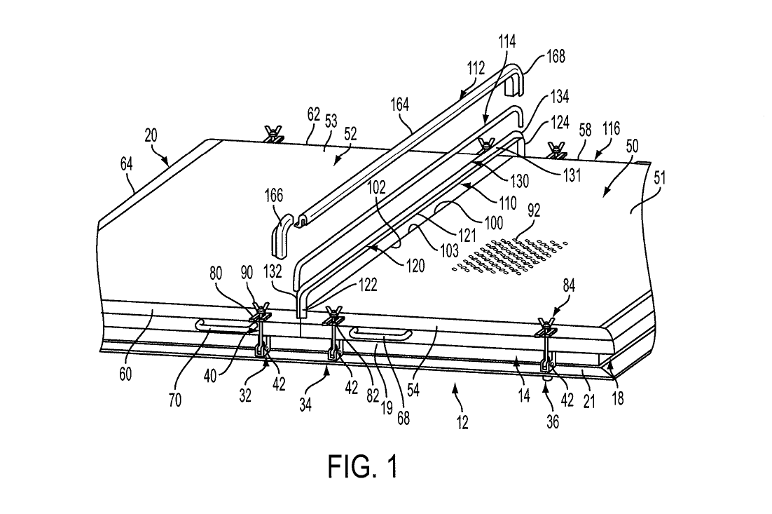

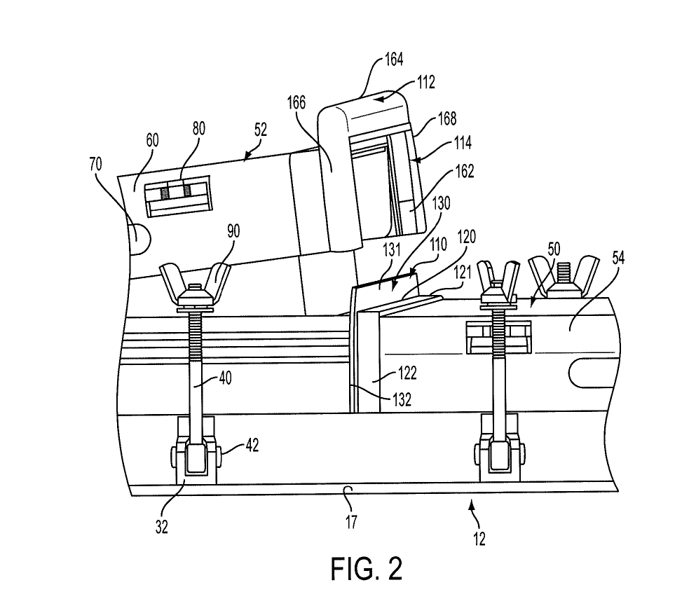

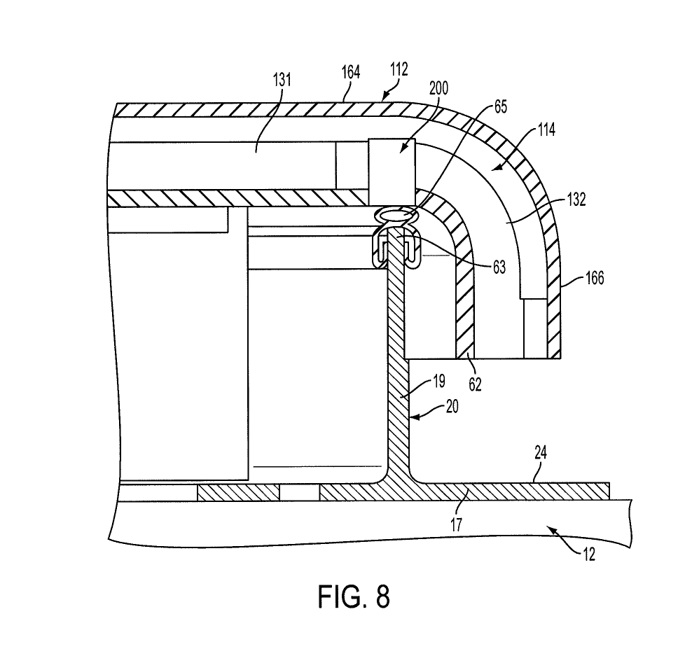

With reference to FIGS. 1 and 2, the illustrated hatch cover comprises a peripheral frame 12 having first and second side sections 14, 16 and first and second end sections 18, 20. The illustrated peripheral frame 12 is comprised of sections that each comprises a base 17 and an upright wall 19 (see FIG. 8). The base has a laterally outwardly extending lip portion 24 positioned at the base of the wall 19. The base and wall can be of an inverted T-shaped cross-section with the wall 19 extending perpendicularly from the base. The frame is desirably watertight about its periphery. The base can be bolted or otherwise fastened to a vault, chamber, tank and/or other structure that defines an opening to be covered by the hatch cover. The exemplary frame shown in FIG. 1 is substantially rectangular.

A plurality of tie-down brackets can be mounted to the side walls (and/or the end walls) of the assembly. Side wall 19 at side 14 of the frame has four such brackets, with three of them being indicated in FIG. 1 by respective numbers 32, 34 and 36. The brackets can each comprise a pair of spaced apart legs to which a fastener is pivoted. One such fastener 40 is shown pivoted by a pin or bolt 42 to the bracket 32 in a position to the left center of the hatch cover of FIG. 1. The fasteners 40 can, for example, comprise respective externally threaded shafts. The brackets, such as bracket 32, can be welded or otherwise mounted to the frame such as with a base portion of the bracket abutting the upper surface 21 of the rim or frame base and the rear wall of the bracket abutting an adjacent outer side surface of the frame wall 19.

The illustrated hatch cover of FIG. 1 comprises first and second hatch cover portions such as leaves or doors 50, 52. Leaf 50 is provided with a downturned lip or overhanging edge portion consisting of or comprising a first side portion 54, a second side portion 56, and a third side portion 58. The second hatch cover portion 52 is similarly provided with a downturned lip or overhanging edge portion consisting of or comprising a first downturned side portion 60, a second downturned side portion 62 and a third downturned end portion 64. The side portions 60, 62 and 64 are desirably formed together where they intersect at respective corners. The portions 54, 56 and 58 also are desirably joined together where they intersect. The side portions 60, 62 and 64 extend downwardly from the associated sides of the body 53 of cover portion 52. The side portions 54, 56, 58 also extend downwardly from the associated sides of the body 51 of the cover portion 50. The cover portion bodies can be plates of a durable material such as aluminum, steel and/or a composite material. The respective downturned side portions of the cover portions overlie the upper end 63 of the frame walls 19 (see FIG. 8). A seal 65 is shown compressed by a portion of the closed leaf 52 in FIG. 8. The seal 65 comprises a perimeter seal that desirably extends about the entire periphery of the frame at the upper or distal end of the wall 19. The seal 65 can be of any suitable gasket material such as EPDM closed cell foam rubber.

As can be seen in FIG. 1, a handle 68 can be mounted to cover portion 50 and a handle 70 can be mounted to cover portion 52. A similar handle can be provided at the opposite side of each of the respective cover portions. The handles are used to lift the respective cover portions from the frame when it is desired to open the hatch. The ends of the leaves can be pivoted to the frame, if desired, so that the leaves can be pivoted to an open position. Conventional hold open devices, such as piston/cylinder hatch lift support devices, can operate to hold the leaves open when they are pivoted to an open position. Alternatively, the sides of the leaves can be pivoted to the frame in a side opening design.

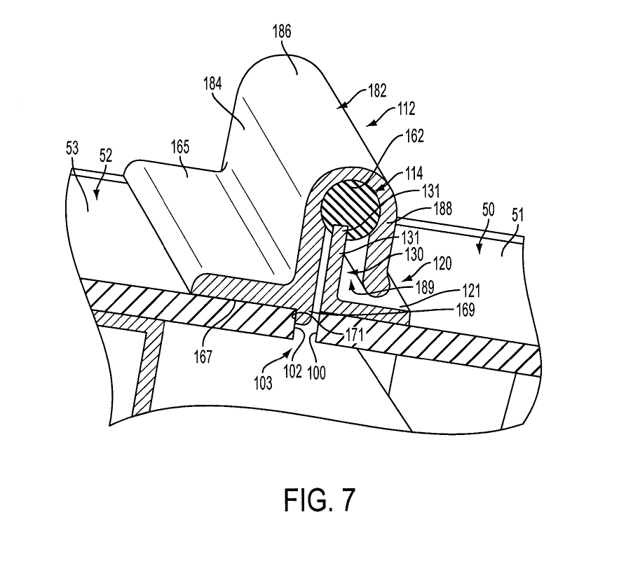

Each of the cover portions can be provided with a plurality of fastener engaging members such as member 80, 82 and 84. In general there is one such engaging member provided in association with and above an associated bracket. Thus, engaging member 80 is positioned above bracket 32, engaging member 82 is positioned above bracket portion 34 and engaging member 84 is positioned above bracket 36. The illustrated engaging members in this example each comprise a flange that defines a slot for receiving the distal end of a respective associated fastener. Thus, the distal end of fastener 40 can be positioned, in this example, into the slot defined by engaging member 80. A nut or other hold down device such as a wing nut 90 (one being numbered in FIG. 1) can be tightened to clamp the cover section 52 to the frame. Thus, the hatch portions can be secured in place. When clamped, the perimeter seal 65 is compressed and seals the gap between the distal or upper end of the frame walls and adjacent under surfaces of the hatch cover portion bodies. A grid or other friction increasing pattern, such as indicated by number 92 in FIG. 1, can be provided on the upper surface of the cover portions for anti-slip purposes. The two hatch cover portions 50, 52 have respective adjacent end portions 100, 102 that abut one another, with a gap 103 therebetween that extends transversely across the hatch opening when the hatch cover portions 50, 52 are secured in place. See also FIG. 7. A gap is also present if one cover section edge portion overlaps the other cover portion edge portion. The hatch covers and frame are not required to be rectangular as they can be round, oval or any other desired shape while still utilizing the leaf gap sealing mechanism of this disclosure. In such a case, the surfaces of these structures at the periphery of the hatch cover portions can still be referred to as sides even though not planar.

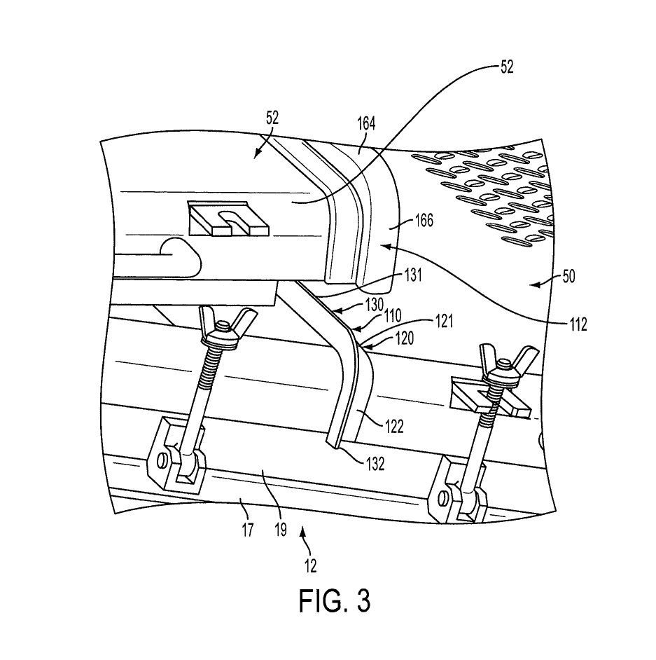

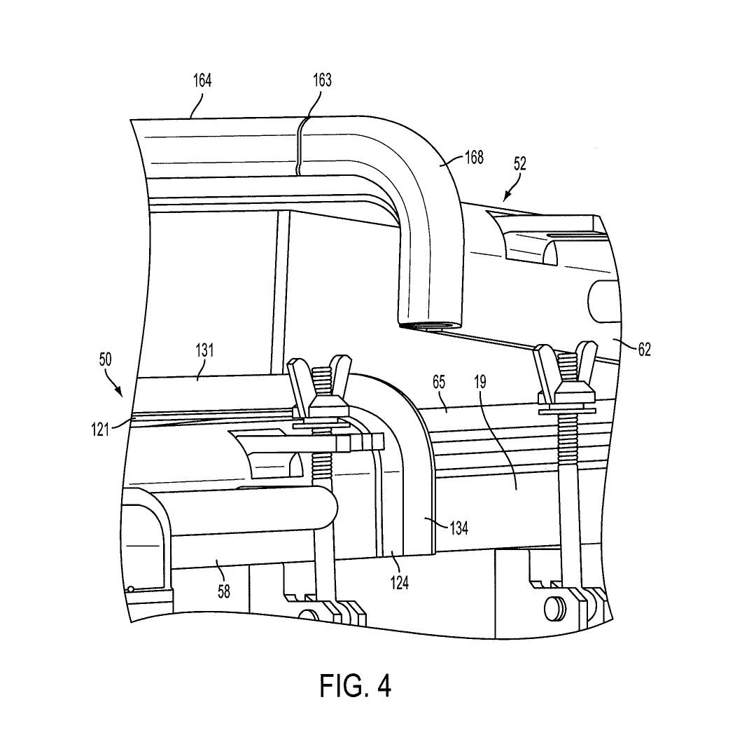

Sealing of the gap that extends transversely across the cover portions is accomplished by a central seal, an example of which is shown in FIGS. 1-8. An illustrated form of central seal comprises a dam portion 110, a shield portion 112 and a gap seal member such as an elongated gasket 114. These components will become more apparent with reference to the description of embodiments below.

One exemplary form of a dam portion 110 can be elongated and generally U-shaped (shown inverted in the orientation of the figures) with a base portion 120 designed to abut the upper surface of leaf 50 adjacent to the gap 103 between the two leaf portions 50, 52 and a seal engaging projection 130 extending outwardly from the base portion 120. Base portion 120 in this example has a central portion 121 transversely spanning the upper surface of cover portion 50 along the edge of the gap 103; a first end portion 122 that extends across the corner where hatch cover body 51 intersects the hatch cover side portion 54, and downwardly below the upper end or distal end of the adjacent wall 19; and another end portion 124 (see FIG. 1) that overlaps the intersection of body 51 and side portion 58 and extends downwardly beyond the upper or distal end of the adjacent frame wall 19. The base portion 120 can be welded or otherwise mounted to the hatch cover portion 52.

The seal engaging projection 130 can comprise a central portion 131 extending upwardly from base section 121 and end portions 132, 134 extending outwardly from the respective base portions 122, 124. Thus, seal engaging projection 130 in this example comprises a U-shaped outwardly projecting flange portion. The illustrated dam portion 110 is of a right angular cross-section, but it can be of other configurations. The dam projection 130 in this example comprises a plate with a distal seal engaging end or end portion (distal meaning spaced from base 120).

The seal 114 in one example comprises a generally U-shaped seal, such as a sealing rod having a round cross-section of a compressible material, such as of EPDM closed cell foam. Other compressible sealing materials of different cross-sections can be used. The seal in this example is positioned within a groove or channel 162 defined by the shield or gap covering portion 112 of the seal. FIG. 2 illustrates a portion of the groove 162. The illustrated shield portion 112 comprises a central section 164 and respective end sections 166, 168. Together the end sections 166, 168 and central portion 164 define a continuously extending U-shaped groove or channel for receiving the seal 114. Other seal accommodating and/or engaging features can alternatively be provided in the shield portion.

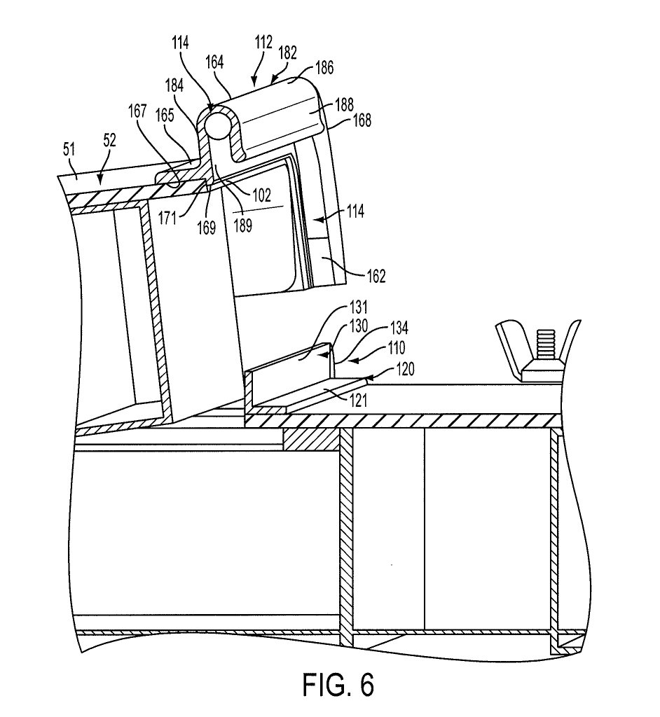

The end sections 166, 168, if not formed as one piece with the central section 164, can be welded or otherwise secured to the central section to form the shield portion 112. With reference to FIG. 6 and to central section 164, each of the shield sections can comprise a base portion 165 having a lower mounting surface 167 positioned adjacent to or abutting the upper surface of the leaf body 51 of leaf 52 along the edge 102 of the leaf 52 for mounting or coupling to the leaf, such as by welding. The base 165 can have a flange portion 169 overlapping the edge 102, or a portion of the edge, of leaf 52 and defining a notch 171 for receiving the edge of leaf 52 (See also FIG. 7).

As can be seen in FIGS. 6 and 7, the shield portion 112 also comprises a dam receiving channel defining portion 182 comprising a first leg portion 184 extending upwardly from base portion 165 and away from leaf 52, a cross portion 186 spanning the gap 103 between the leaves and a second leg portion 188 spaced from the first leg portion 184 and extending from the cross portion toward leaf 50 but terminating short of the leaf 50; whereby a dam projection receiving gap 189 is defined between the legs. The shield portion can be of a generally inverted U-shaped configuration. In FIG. 7, the cross portion 186 defines a seal receiving channel 162. The illustrated channel 162 is circular in cross-section and is located adjacent to cross portion 186 and has a narrowed entrance opening, such that the seal is held in the channel by portions of the legs 184, 186. The distal edges of the projections 131, 132, 134 of dam portion 110 engage and compress the seal 114 when the hatch cover portions or leaves 50, 52 are closed (see FIG. 7) to provide a watertight and insect-tight seal along the length of the gap 103.

Although not required, the various components can be extruded, such as of aluminum or other durable materials, with the extrusions assembled onto the hatch cover.

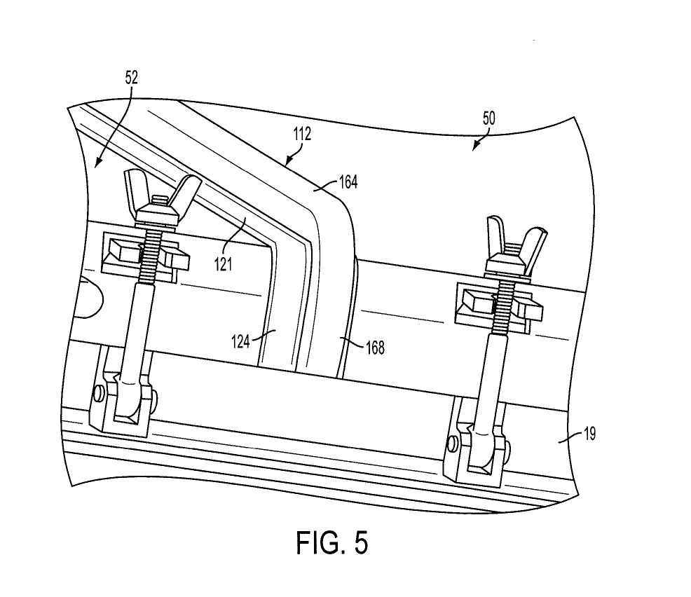

Thus, as can be seen in FIGS. 5 and 7, when the respective hatch cover portions 50, 52 are closed, the outwardly projecting flange portion of the dam 110 engages the seal 114 and thereby seals the covered area against the entrance of water and insects.

As is apparent from FIG. 7, water (such as rainwater) impinging the shield portion 112 flows generally from the cross portion 186, along the outer surfaces of either of the leg portions 184, 188, and away from the gap between the cover portions 50, 52. In addition, to the extent any water backs up along the upper surface of the base of the dam portion and toward the gap 189, the seal 114 prevents this water from entering the housing or vessel covered by the hatch cover.

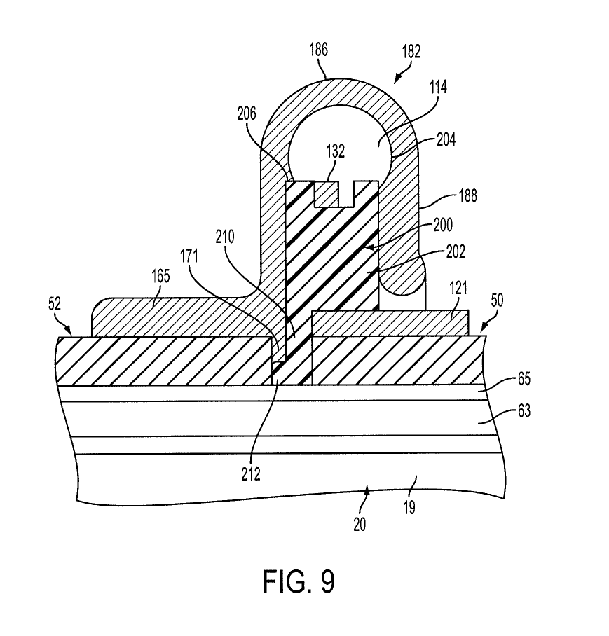

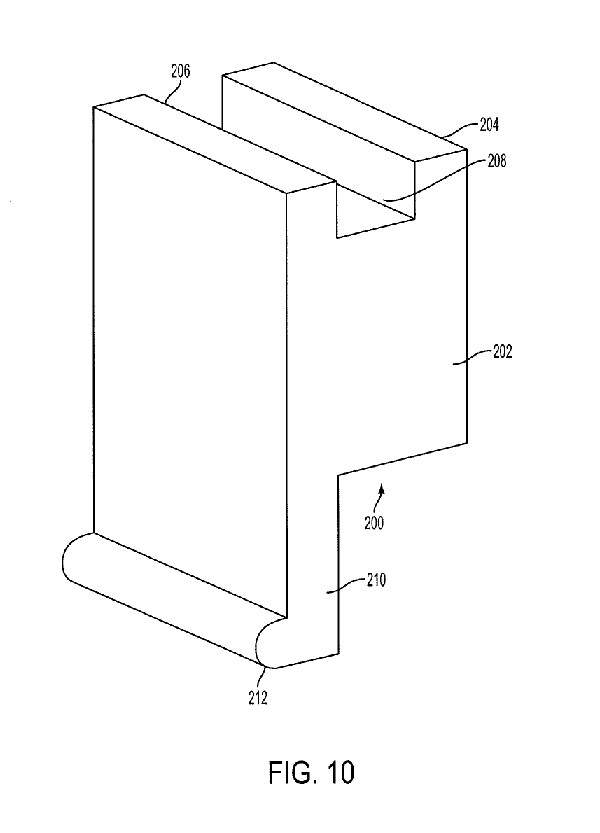

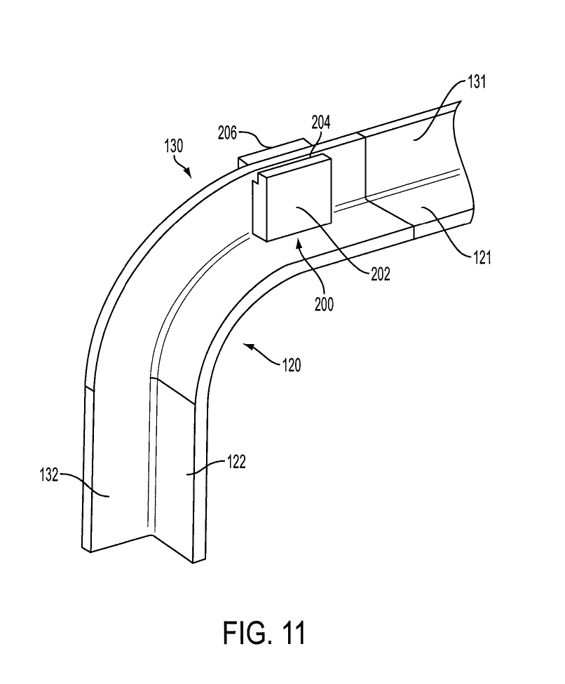

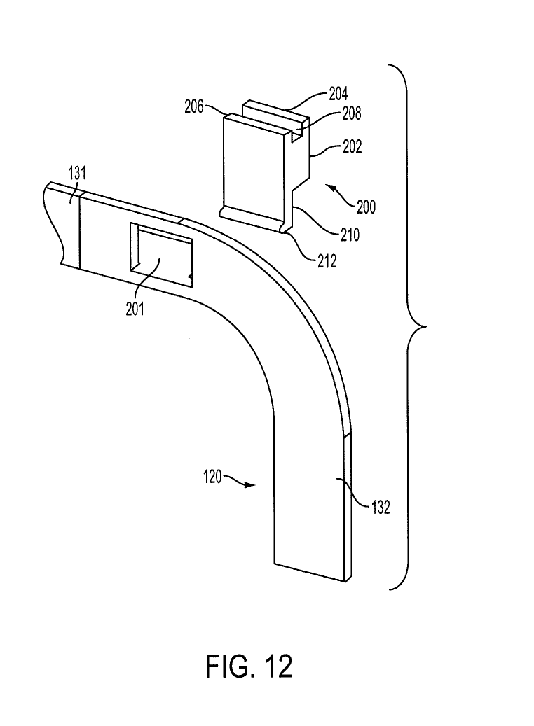

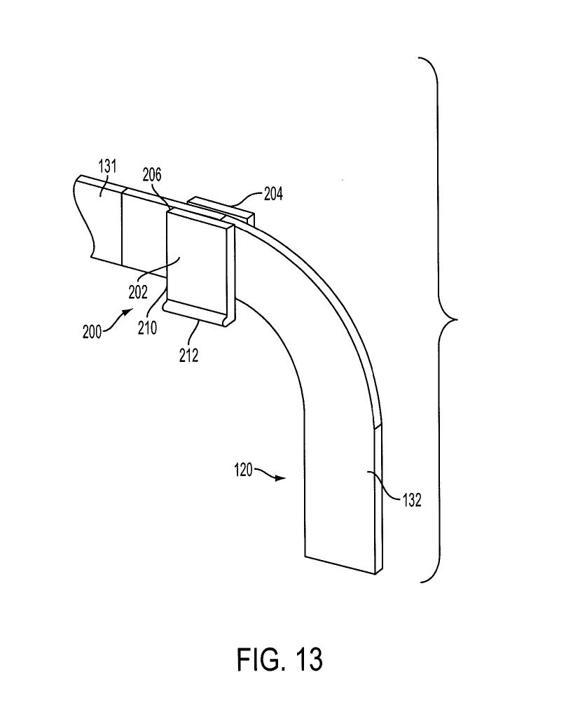

FIGS. 9-13 illustrate one form of side gap seal that can be used to seal the gap between the upper end of the wall 19 (and wall seal portion 65) and the seal 114 within shield portion 112 at this location where the shield portion passes over the wall seal. Since the side gap seals can be the same if desired, only the side gap seal at one side of the hatch cover will be described in detail. A respective side gap seal is positioned at each side of the hatch cover. In one exemplary approach, an opening 201 (FIG. 12) is provided through dam wall portion 132, adjacent to dam wall portion 131 and at a location above the wall 19 when the hatch cover is closed. The opening can be rectangular or of another shape. Desirably, the opening is bounded on all sides by a portion of the dam projection. A side gap seal is positioned in opening 201 with a portion extending downwardly into engagement with wall seal 65 when the hatch cover portions are closed. The side gap seal can be of the same or of a different compressible material than the wall seal 65. In one specific form, the side gap seal comprises a seal 200 comprising a body 202 shaped for insertion into opening 201. The body comprises upwardly extending spaced apart legs 204, 206 defining a slot 208 therebetween. A portion of the dam wall 132 bounding the upper periphery of the opening 201 is positioned in the slot 208 when the gap seal is in place. The side gap seal also comprises a downwardly extending leg 210 with a projecting foot portion 212 at the lower end of the leg.

FIG. 9 shows the side gap seal in place. The legs 204, 206, 210 and foot portion 212 are positioned to seal the side gap between seals 65 and 114 to thereby seal the side gaps between the hatch cover portions 50, 52 when the hatch cover is closed. Foot portion 212 engages and compresses seal 65 to seal the space between the lower edge of projection 171 of the exemplary shield portion and the wall seal portion 65. Other gap seal configurations can be used. The upper ends of the legs 204,206 engage the seal 114 on opposite sides of the dam to seal the upper portion of the side gap.

A hatch cover in accordance with this disclosure provides a watertight seal. This is particularly desirable on hatch covers used for closing openings in covered water reservoirs or the like where rainwater and other pollutants could otherwise run into the reservoir through the opening.

Having illustrated and described the principles of this invention with reference to exemplary embodiments, it should be apparent to those of ordinary skill in the art that the embodiments may be modified in arrangement and detail without departing from the principles of this invention. All such modifications are encompassed in this disclosure.

I claim:

1. A hatch cover comprising:
a frame with an opening through the frame,
first and second hatch cover portions overlying the opening and closing the opening when the first and second hatch cover portions are in a closed position;
the first hatch cover portion having a first edge positioned to extend across the opening when the first cover portion is in a closed position, the second hatch cover portion having a second edge positioned to extend across the opening when the second hatch cover portion is in a closed position;
an elongated dam projecting outwardly from the first hatch cover portion and extending along the first edge;
a shield projecting outwardly from the first hatch cover portion and extending along the second edge, the shield defining an elongated channel positioned to receive the dam therein when the first and second hatch cover portions are in a closed position; and
a gap seal member positioned in the channel and engaged by the dam projection when the first and second hatch cover portions are in the closed position.

2. A hatch cover according to claim 1 wherein the frame comprises a frame base and a wall projecting outwardly from the frame base, the wall surrounding the opening, the wall having a distal end portion spaced from the frame base, a perimeter seal coupled to the distal end portion of the frame wall and positioned to provide a seal between the distal end portion of the frame wall and the first and second hatch cover portions when the first and second hatch cover portions are in a closed position.

3. A hatch cover according to claim 2 having first and second hatch cover sides, wherein the first and second edges each extend from the first hatch cover side to the second hatch cover side, the hatch cover comprising first and second side gap seals each coupled to a respective one of the dams and the shield, the side gap seals being configured to engage the gap seal member and the perimeter seal, the first side gap seal being positioned to seal the space between the perimeter seal and the gap seal member at a location adjacent to the first hatch cover side, and the second side gap seal being positioned to seal the space between the perimeter seal and the gap seal member at a location adjacent to the second hatch cover side.

4. A hatch cover according to claim 3 wherein the dam has a first side gap seal receiving opening adjacent to the first hatch cover side and a second side gap seal receiving opening adjacent to the second hatch cover side, the first side gap seal comprising a first seal body positioned at least in part within and associated with the first side gap seal receiving opening, the second side gap seal comprising a second side gap seal body positioned at least in part within and associated with the second side gap seal receiving opening, the first side gap seal comprising respective first and second leg portions positioned at opposite sides of the dam and extending from the first seal body into engagement with the gap seal member when the first and second hatch cover portions are in a closed position, the first side gap seal comprising a respective third leg extending from the first seal body in a direction away from the first and second legs of the first side gap seal and into engagement with the perimeter seal when the first and second hatch cover portion are in a closed position; and the second side gap seal comprising respective first and second leg portions positioned at opposite sides of the dam and extending from the second seal body into engagement with the gap seal member when the first and second hatch cover portions are in a closed position, the second side gap seal comprising a respective third leg extending from the second seal body and in a direction away from the first and second legs of the second side gap seal and into engagement with the perimeter seal when the first and second hatch cover portions are in a closed position.

5. A hatch cover according to claim 4 wherein the third leg of each of the first and second side gap seals comprises an enlarged foot portion positioned to abut the perimeter seal when the first and second hatch cover portions are in a closed position, the shield comprising at least one side gap seal engaging projection positioned to engage the respective side gap seal feet of the first and second side gap seals when the first and second hatch cover portions are in a closed position.

6. A hatch cover according to claim 5 in which the side gap seal receiving openings are bounded on all sides by a portion of the dam.

7. A hatch cover according to claim 1 wherein the shield and dam are each substantially u-shaped.

8. A hatch cover according to claim 7 wherein the first and second hatch cover portions are substantially rectangular, each of the first and second hatch cover portions comprise a hatch cover body portion that each overlies a portion of the opening when in a closed position, the first and second hatch cover portions each comprising a hatch cover end portion projecting downwardly from the hatch cover body portion at a location spaced from the gap, and first and second hatch cover side portions connected to the hatch cover end portion and projecting downwardly from the hatch cover body portion at opposed sides of the hatch cover body portion, and wherein the frame is rectangular.

9. A hatch cover comprising:
a frame with an upright wall and with an opening through the frame,
first and second hatch cover portions supported by the frame and overlying the wall, the first and second hatch cover portions closing the opening when in a closed position, the first hatch cover portion having a first edge extending across the opening, the second hatch cover portion having a second edge adjacent to the first edge and extending across the opening, the first and second edges defining a gap therebetween;
a dam mounted to the first cover portion and extending along the length of the gap, the dam comprising a dam base coupled to the first cover portion and a dam projection extending outwardly from the dam base;
a shield mounted to the second cover portion and extending along the length of the gap, the shield comprising a shield base coupled to the second cover portion and extending along the length of the gap, the shield comprising a gap cover portion positioned to overlie the gap, the gap cover portion comprising a first shield leg portion extending from the shield base portion and away from the second cover portion, a cross member portion overlying the gap and spaced from the first and second cover portions, and a second shield leg portion extending from the cross member position toward the first cover portion;
the dam and shield being positioned and configured such that the dam projection is positioned between the first and second leg portions when the first and second hatch cover portions are in a closed position; and
a gap seal member positioned between the first and second leg portions, the gap seal member being engaged by the dam projection when the first and second hatch cover portions are in a closed position.

10. A hatch cover according to claim 9 wherein the wall has a distal end surrounding the opening, a perimeter seal positioned to seal the gap between the distal end of the wall and the first and second hatch cover portions when the first and second hatch cover portions are in a closed position.

11. A hatch cover according to claim 10 wherein the perimeter seal extends entirely around the opening and is coupled to the distal end of the wall.

12. A hatch cover according to claim 11 comprising first and second side gap seals each coupled to a respective one of the dams and the shield and configured to engage the gap seal member and the perimeter seal, the first side gap seal being positioned to seal the space between the perimeter seal and the gap seal member at a first end portion of the gap, and the second side gap seal being positioned to seal the space between the perimeter seal and the gap seal member at a second end portion of the gap.

13. A hatch cover according to claim 12 wherein the first and second side gap seals are coupled to the dam.

14. A hatch cover according to claim 13 having first and second hatch cover sides, wherein the dam has a first side gap seal receiving opening adjacent to the first hatch cover side and a second side gap seal receiving opening adjacent to the second hatch cover side, the first side gap seal comprising a first seal body positioned at least in part within and associated with the first side gap seal receiving opening, the second side gap seal comprising a second seal body positioned at least in part within and associated with the second side gap seal receiving opening, the first side gap seal comprising respective first and second leg portions positioned at opposite sides of the dam and extending from the first seal body and into engagement with the gap seal member when the first and second hatch cover portions are in a closed position, the first side gap seal comprising a respective third leg extending from the first seal body and in a direction away from the first and second legs of the first side gap seal and into engagement with the perimeter seal when the first and second hatch cover portions are in a closed position; and
the second side gap seal comprising respective first and second leg portions positioned at opposite sides of the dam and extending from the second seal body and into engagement with the gap seal member when the first and second hatch cover portions are in a closed position, the second side gap seal comprising a respective third leg extending from the second seal body and in a direction away from the first and second legs of the second side gap seal and into engagement with the perimeter seal when the first and second hatch cover portions are in a closed position.

15. A hatch cover according to claim 14 wherein the third leg of each of the first and second side gap seals comprises an enlarged foot portion positioned to abut the perimeter seal when the first and second hatch cover portions are in a closed position, the shield base comprising at least one side gap seal engaging projection extending in a direction away from the cross portion and into engagement with the side gap seal feet of the first and second side gap seals when the first and second hatch cover portions are in a closed position.

16. A hatch cover according to claim 15 in which the side gap seal receiving openings are rectangular and are bounded on all sides by a portion of the dam.

17. A hatch cover according to claim 16 wherein the shield and dam are each substantially u-shaped.

18. A hatch cover according to claim 9 wherein the first and second hatch cover portions are rectangular, each of the first and second hatch cover portions comprise a hatch cover body portion that each overlies a portion of the opening when the first and second hatch cover portions are in a closed position, the first and second hatch cover portions each comprising a hatch cover end portion projecting downwardly from the hatch cover body portion at a location spaced from the gap, and first and second hatch cover side portions connected to the hatch cover end portion and projecting downwardly from the hatch cover body portion at opposed sides of the hatch cover body portion, and wherein the frame is rectangular.

19. A hatch cover comprising:
a frame with an opening through the frame,
first and second hatch cover portions overlying the opening and closing the opening when the first and second hatch cover portions are in a closed position;
the first hatch cover portion having a first edge positioned to extend across the opening when the first cover portion is in a closed position, the second hatch cover portion having a second edge positioned to extend across the opening when the second hatch cover portion is in a closed position;
an elongated dam projecting outwardly from the first hatch cover portion and extending along the first edge;
a shield projecting outwardly from the first hatch cover portion and extending along the second edge, the shield defining an elongated channel positioned to receive the dam therein when the first and second hatch cover portions are in a closed position;
a gap seal member positioned in the channel and engaged by the dam projection when the first and second hatch cover portions are in the closed position;
wherein the frame comprises a frame base and a wall projecting outwardly from the frame base, the wall surrounding the opening, the wall having a distal end portion spaced from the frame base, a perimeter seal coupled to the distal end portion of the frame wall and positioned to provide a seal between the distal end portion of the frame wall and the first and second hatch cover portions when the first and second hatch cover portions are in a closed position;
the hatch cover having first and second hatch cover sides, and wherein the first and second ledges each extend from the first hatch cover side to the second hatch cover side, wherein a hap is provided between the first and second edges, first and second side gap seals each coupled to a respective one of the dams and the shield and configured to engage the gap seal member and the perimeter seal, the first side gap seal being positioned to seal the space between the perimeter seal and the gap seal member at a location adjacent to the first hatch cover side, and the second side gap seal being positioned to seal the space between the perimeter seal and the gap seal member at a location adjacent to the second hatch cover side;
wherein the dam has a first side gap seal receiving opening adjacent to the first hatch cover side and a second side gap seal adjacent to the second hatch cover side, the first side gap seal comprising a first seal body positioned at least in part within and associated with the first side gap seal receiving opening, the second side gap seal comprising a second end gap seal body positioned at least in part within and associated with the second end gap seal receiving opening, the first side gap seal comprising respective first and second leg portions positioned at opposite sides of the dam and extending from the first seal body and into engagement with the gap seal member when the first and second hatch cover portions are in a closed position, the first side gap seal comprising a respective third leg extending from the first seal body and in a direction away from the first and second legs of the first side gap seal and into engagement with the perimeter seal when the first and second hatch cover portions are in a closed position, and the second side gap seal comprising respective first and second leg portions positioned at opposite sides of the dam and extending from the second seal body and into engagement with the gap seal member when the first and second hatch cover portions are in a closed position, the second side gap seal comprising a respective third leg extending from the second seal body and in a direction away from the first and second legs of the second side gap seal and into engagement with the perimeter seal when the first and second hatch cover portions are in a closed position;
wherein the third leg of each of the first and second side gap seals comprises an enlarged foot portion positioned against the perimeter seal when the first and second hatch cover portions are in a closed position, the shield comprising at least one side gap seal engaging projection positioned to engage the side gap seal feet of the first and second side gap seals when the first and second hatch cover portions are in a closed position;
wherein the side gap seal receiving openings are bounded on all sides by a portion of the dam;
wherein the shield and dam are each substantially u-shaped; and
wherein the first and second hatch cover portions are substantially rectangular, each of the first and second hatch cover portions comprise a hatch cover body portion that each overlies a portion of the opening when in a closed position, the first and second hatch cover portions each comprising a hatch cover end portion projecting downwardly from the hatch cover body portion at a location spaced from the gap, and first and second hatch cover side portions connected to the hatch cover end portion and projecting downwardly from the hatch cover body portion at opposed sides of the hatch cover body portion, and wherein the frame is rectangular;
